(19) United States
(12) Patent Application Publication
(10) Pub. No.: US 2019/0170173 A1
(43) Pub. Date: Jun. 6, 2019

(54) multi-angle toothed interlocking system

(71) Applicant: Ali Aboud, Burnaby BC (CA)

(72) Inventor: Ali Aboud, Burnaby BC (CA)

(21) Appl. No.: 16/271,859

(22) Filed: Feb. 10, 2019

Related U.S. Application Data
(60) Provisional application No. 62/780,927, filed on Dec. 18, 2018.

(51) Int. Cl. F16B 5/07

(52) U.S. Cl. CPC F16B 5/07

(57) ABSTRACT

An attachment element is provided. The attachment element has a base that has one or more toothed heads and one or more toothed cavities. The one or more toothed heads has a plurality of notches at its periphery. The plurality of notches are spaced apart at an predefined incremental degree. The one or more toothed cavities and one or more toothed heads are mating structures.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to an attachment element. More so, the present invention relates to a gear-shaped attachment element.

### Description of the Related Art

Building blocks are commonly used in several applications such as children games, modular construction materials, and so forth. Building blocks for children games allow children to make various three dimensional shapes. The use of building blocks enables modular construction techniques for building bridges, buildings, and so forth.

With typical building blocks like Lego for instance, one push fits the blocks only in parallel or perpendicular to the interlocking axis. Only parallel or perpendicular interlocking of building blocks limits the possibility of making three dimensional complex shapes.

In light of the above mentioned drawbacks, there exists a need of building blocks that can be interlocked along multiple axis.

### BRIEF SUMMARY OF THE INVENTION

A primary object of the disclosure is to provide building blocks that can interlocked on incremental angles.

Another object of the present disclosure is to provide building blocks that can interlocked on incremental angles around a single axis.

Yet another object of the present disclosure is to provide building blocks that can be used for several applications such as construction, machine, games and so forth.

### DESCRIPTION OF THE DRAWINGS

Having thus described the disclosure in general terms, reference will now be made to the accompanying figure, wherein:

FIG. 1 illustrates an attachment element, in accordance with an embodiment of the present disclosure,

FIG. 2 illustrates a one or more toothed heads, in accordance with an embodiment of the present disclosure,

FIG. 3 illustrates a one or more toothed cavities, in accordance with an embodiment of the present disclosure,

FIG. 4 illustrates an interlock between an attachment element and a second attachment element, in accordance with an embodiment of the present disclosure, and

FIG. 5 illustrates an interlock between a one or more toothed heads and a one or more toothed cavities, in accordance with an embodiment of the present disclosure.

It should be noted that the accompanying figures are intended to present illustrations of exemplary embodiments of the present disclosure. This figure is not intended to limit the scope of the present disclosure. It should also be noted that accompanying figure is not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figure is intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

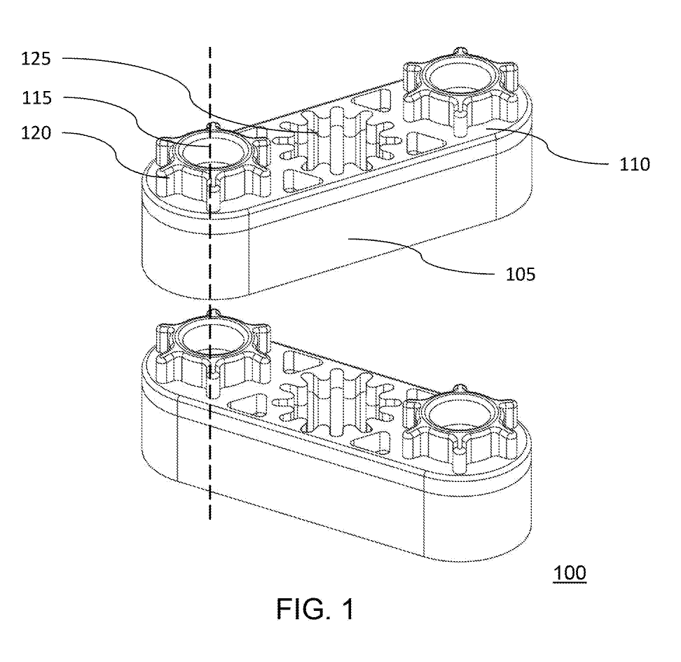

FIG. 1 illustrates an attachment element 100, in accordance with an embodiment of the present disclosure. The attachment element 100 has a base 105. The base 105 is defined by a plane 110 and an interlocking axis 115. The interlocking axis 115 is substantially perpendicular to the plane 110. It will be understood to a person ordinarily skilled in the art that the interlocking axis 115 and the plane 110 can be in the range of 80 to 100 degrees.

The base 105 has one or more toothed heads 120 and the one or more toothed cavities 125. The one or more toothed heads 120 are elevated compared to the plane 110. The one or more toothed heads 120 and the one or more toothed cavities 125 are explained in detail with respect to subsequent FIGs. The one or more toothed heads 120 and the one or more toothed cavities 125 are mating structures.

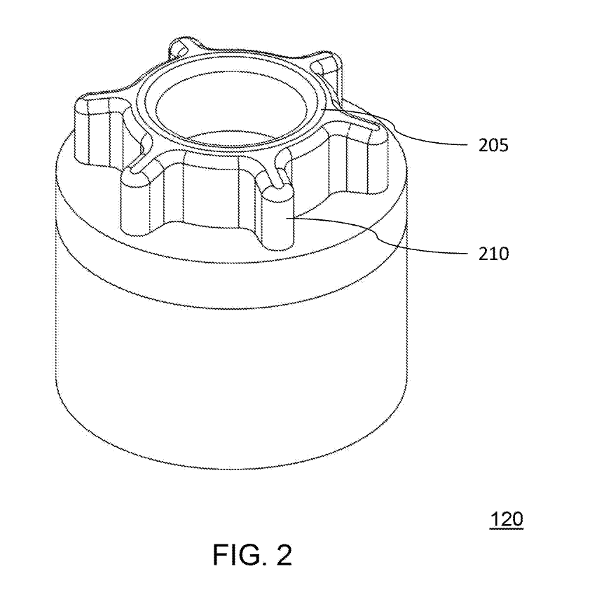

FIG. 2 illustrates the one or more toothed heads 120, in accordance with an embodiment of the present disclosure. The one or more toothed heads 120 has a periphery 205. In an embodiment of the present disclosure, the one or more toothed heads 120 are gear like structures. The toothed head 210 has a plurality of notches 210 at the periphery 205. The plurality of notches 210 are spaced apart at a predefined incremental degree. It will be understood to a person ordinarily skilled in the art that the plurality of notches 210 can be of any shape such as a triangular shape, a rectangular shape, a curved shape, and a random shape. In an embodiment of the present disclosure, the predefined incremental degree is 30 degrees. It should be understood that the predefined incremental degree can be any fixed interval such as 1 degrees, 5 degrees, and so forth, without impacting the scope of the disclosure. In an embodiment of the present disclosure, the one or more toothed heads 120, the one or more toothed cavities 125 and the base 105 are defined by a first predefined height.

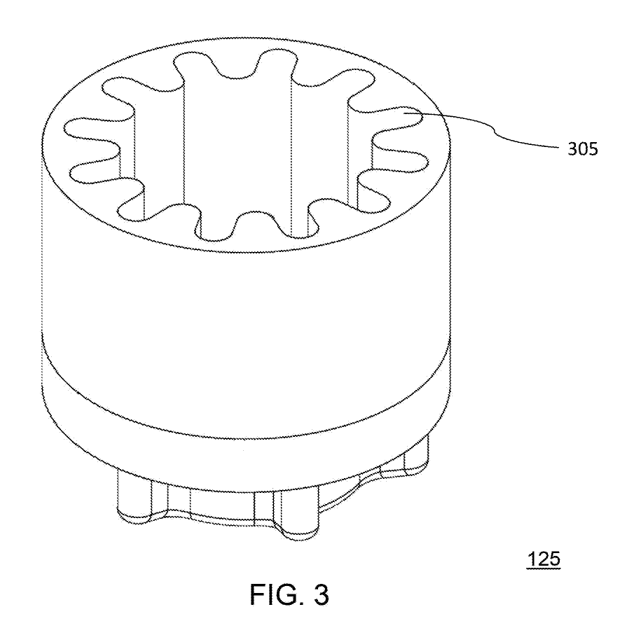

FIG. 3 illustrates the one or more toothed cavities 125, in accordance with an embodiment of the present disclosure. The one or more toothed cavities 125 has a shape that enables mating with the one or more toothed heads 120. A plurality of cavity notches 305 allows it to be interlocked with the plurality of notches 210 of the one or more toothed heads 120 of a second attachment element. In an embodiment of the present disclosure, the attachment element 100 interlocks with a second attachment element. Interlocking of the attachment element 100 and the second attachment element is described in subsequent FIGs.

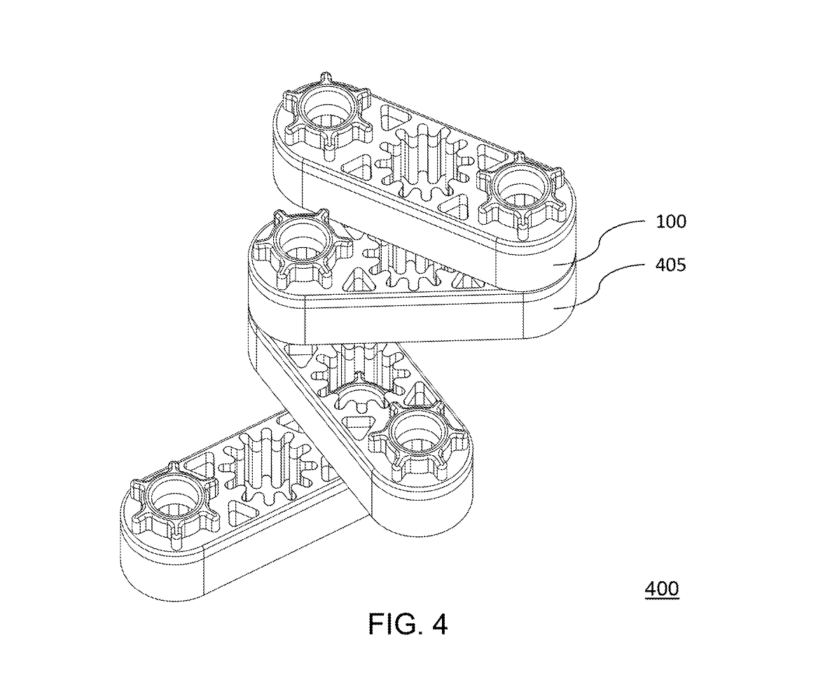

FIG. 4 illustrates an interlock 400 between the attachment element 100 and a second attachment element 405, in accordance with an embodiment of the present disclosure. The attachment element 100 and the second attachment element interlocks such that the plurality of notches 210 of the one or more toothed heads 120 of the second attachment element 405 interlocks with the plurality of cavity notches 305 of the one or more toothed cavities 125 of the attachment element 100. It will be understood to a person ordinarily skilled in the art that several of such attachment elements can be interlocked at various orientations to form random and complex shapes.

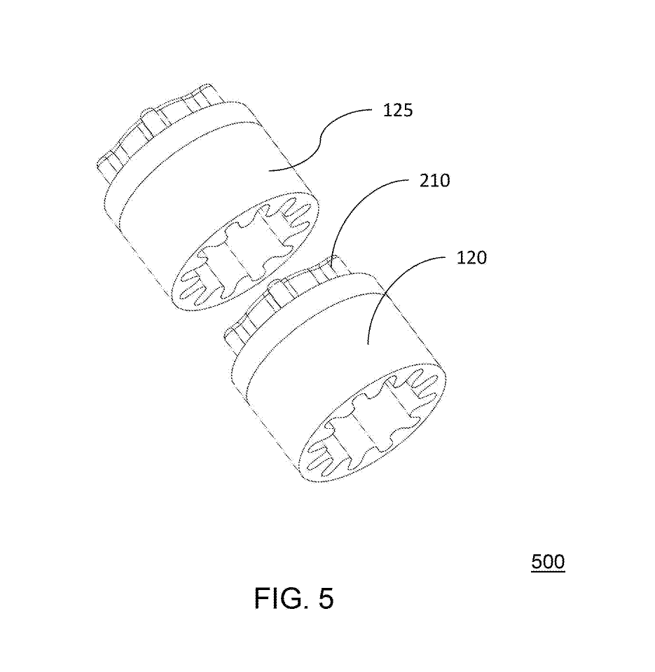

FIG. 5 illustrates an interlock 500 between the one or more toothed heads 120 and the one or more toothed cavities 125, in accordance with an embodiment of the present disclosure. It will be understood that the FIGs are for illustration purpose only and the disclosure can be practiced various combinations of shapes, sizes, number and orientation of notches, toothed heads and toothed cavities. Also, the attachment element 100 can have any number of toothed heads and toothed cavities. In an embodiment of the present disclosure, attachment elements can have different number of toothed heads and toothed cavities on them.

Present disclosure provides several advantages over existing art. The attachment elements can be push fit with each other in incremental degrees depending on the total number of teeth. It allows creation of more random and complex structures that are not possible with the current available building blocks.

What is claimed is:

1. An attachment element comprising:
a base, wherein the base is defined by a plane and an interlocking axis, wherein the interlocking axis is substantially perpendicular to the plane, wherein the base comprising
one or more toothed heads, wherein the one or more toothed heads are elevated compared to the plane, wherein the one or more toothed heads has a periphery, wherein each toothed head of the one or more toothed heads has a plurality of notches at the periphery, wherein the plurality of notches are spaced apart at an predefined incremental degree; and
one or more toothed cavities, wherein the one or more toothed cavities and one or more toothed heads are mating structures.

2. The attachment element as claimed in claim 1, wherein the plurality of teethes can be a triangular shape, a rectangular shape, a curved shape, and a random shape.

3. The attachment element as claimed in claim 1, wherein the predefined incremental degree is 30 degrees.

4. The attachment element as claimed in claim 1, wherein the one or more toothed heads are gear like structures.

5. The attachment element as claimed in claim 1, wherein the one or more toothed heads, the one or more toothed cavities and the base are defined by a first predefined height.

6. The attachment element as claimed in claim 1, wherein the attachment element interlocks with a second attachment element such that the one or more toothed heads of the attachment element interlocks with the one or more toothed cavities of the second attachment element.

7. An attachment element comprising:
a base, wherein the base is defined by a plane and an interlocking axis, wherein the interlocking axis is substantially perpendicular to the plane, wherein the base comprising
one or more toothed heads, wherein the one or more toothed heads are elevated compared to the plane, wherein the one or more toothed heads are gear like structures, wherein the one or more toothed heads has a periphery, wherein each toothed head of the one or more toothed heads has a plurality of notches at the periphery, wherein the plurality of notches are spaced apart at an predefined incremental degree; and
one or more toothed cavities, wherein the one or more toothed cavities and one or more toothed heads are mating structures.

8. The attachment element as claimed in claim 7, wherein the plurality of teethes can be a triangular shape, a rectangular shape, a curved shape, and a random shape.

9. The attachment element as claimed in claim 7, wherein the predefined incremental degree is 30 degrees.

10. The attachment element as claimed in claim 7, wherein the one or more toothed heads, the one or more toothed cavities and the base are defined by a first predefined height.

11. The attachment element as claimed in claim 7, wherein the attachment element interlocks with a second attachment element such that the one or more toothed heads of the attachment element interlocks with the one or more toothed cavities of the second attachment element.

12. An attachment element comprising:
a base, wherein the base is defined by a plane and an interlocking axis, wherein the interlocking axis is substantially perpendicular to the plane, wherein the base comprising
one or more toothed heads, wherein the one or more toothed heads are elevated compared to the plane, wherein the one or more toothed heads are gear like structures, wherein the one or more toothed heads has a periphery, wherein each toothed head of the one or more toothed heads has a plurality of notches at the periphery, wherein the plurality of notches are spaced apart at an predefined incremental degree, wherein the predefined incremental degree is 30 degrees; and
one or more toothed cavities, wherein the one or more toothed cavities and one or more toothed heads are mating structures.

13. The attachment element as claimed in claim 12, wherein the plurality of teethes can be a triangular shape, a rectangular shape, a curved shape, and a random shape.

14. The attachment element as claimed in claim 12, wherein the one or more toothed heads, the one or more toothed cavities and the base are defined by a first predefined height.

15. The attachment element as claimed in claim 12, wherein the attachment element interlocks with a second attachment element such that the one or more toothed heads of the attachment element interlocks with the one or more toothed cavities of the second attachment element.
